(19) United States
(12) Patent Application Publication
(10) Pub. No.: US 2015/0171941 A1
(43) Pub. Date: Jun. 18, 2015

(54) COMMUNICATION SYSTEM, COMMUNICATION METHOD, BASE STATION DEVICE, AND MOBILE STATION DEVICE

(71) Applicant: Sharp Kabushiki,, Osaka-shi, Osaka (JP)

(72) Inventors: Kozue Yokomakura, Osaka-shi (JP); Takashi Yoshimoto, Osaka-shi (JP); Ryota Yamada, Osaka-shi (JP); Katsuya Kato, Osaka-shi (JP); Minoru Kubota, Osaka-shi (JP)

(21) Appl. No.: 14/412,795

(22) PCT Filed: Jul. 24, 2013
(86) PCT No.: PCT/JP2013/069991

§ 371 Date: Jan. 5, 2015

(30) Foreign Application Priority Data
Jul. 30, 2012 (JP) 2012-168875

(51) Int. Cl. H04B 7/04; H04B 7/06; H04B 7/02

(52) U.S. Cl. CPC H04B 7/0417; H04B 7/024; H04B 7/0626

(57) ABSTRACT

A high degree of interference suppression effect is attained in a communication system in which communication is performed among base station devices in a coordinated manner. A mobile station device 200-1 generates a first channel estimation value of a channel between the mobile station device 200-1 and a base station device 100-1 to which the mobile station device 200-1 is connected, a second channel estimation value of a channel between the mobile station device 200-1 and a base station device 100-2, and a second channel estimation value of a channel between the mobile station device 200-1 and a base station device 100-3, generates first channel state information and second channel state information using the identical number of channel bits while making the amount of information contained in the second channel state information larger than the amount of information contained in the first channel state information, the first channel state information being used to transmit the first channel estimation value, the second channel state information being used to transmit the second channel estimation values, and transmits the first channel state information and the second channel state information to the base station device 100-1. In a case where the base station device 100-2 or the base station device 100-3 has received the first channel state information and the second channel state information, the base station device 100-2 or the base station device 100-3 transmits the first channel state information and the second channel state information to the master base station device 100-1, and the master base station device 100-1 calculates transmission weights used in coordinated control performed by the base station devices, by using the first channel state information and the second channel state information.

### TECHNICAL FIELD

The present invention relates to a communication system, a communication method, a base station device, and a mobile station device for coordinated communication among base station devices in wireless communication.

### BACKGROUND ART

In wireless communication systems for mobile telephones and the like, a plurality of base station devices (eNBs, evolved NodeBs) are disposed so as to entirely cover a wide area, and each of the base station devices is connected to mobile station devices (UE: User Equipment) to thereby perform data communication, and furthermore, manage the connections. An area in which a base station device can be connected to mobile station devices (communication service area) is called a cell, an area obtained by dividing a cell into several areas is called a sector, and each base station device manages connections with mobile station devices on a cell-by-cell basis or on a sector-by-sector basis.

In this case, a mobile station device that is located on a cell or sector boundary is subject to interference (hereinafter called inter-cell interference) caused by a base station device in a neighboring cell or sector (a sector may be called a cell, and therefore, hereinafter a minimum unit of an area is called a cell) other than a base station device to which the mobile station device is connected. Accordingly, the user throughput of a mobile station device that is located on a cell boundary decreases.

As a solution to the impact of such inter-cell interference, coordinated multiple point transmission/reception (CoMP) for coordinated communication among base station devices has been available (NPL 1). As an example of coordinated multiple point transmission/reception, a coordinated control technique has been available in which channel state information is shared among a plurality of base station devices and each base station device performs multiplication by a weighting factor that is used to suppress inter-cell interference on the basis of the shared channel state information to thereby suppress inter-cell interference.

FIG. 1 is a schematic diagram illustrating an example of a configuration of a communication system. As illustrated in FIG. 1, in a cell 10-1 that covers a wide area, there are two cells 10-2 and 10-3 that cover narrow areas. To a base station device 100-j (j is any positive integer, where 1≦j≦3 in FIG. 1) in each cell, one mobile station device 200-k (k is any positive integer, where 1≦k≦3 in FIG. 1) is connected, and the mobile station device 200-k is connected to the base station device 100-j, where k=j. The base station devices 100-j are connected to one another via backhaul lines that utilize wired lines (for example, optical fibers, Internet lines, X2 interface, or the like), wireless links, or the like (not illustrated).

FIG. 2 is a diagram illustrating the definitions of downlink channels (transfer functions) in the communication system in FIG. 1. As illustrated in FIG. 2, a channel between the mobile station device 200-k and the base station device 100-j is denoted by Hₖⱼ. Here, Hₖⱼ (k=j) is a channel relating to a desired signal, and Hₖⱼ (k≠j) is a channel relating to inter-cell interference.

The mobile station device 200-1 estimates channels H₁₁, H₁₂, and H₁₃, and transmits (feeds back) channel estimation values Ĥ₁₁, Ĥ₁₂, and Ĥ₁₃ to the base station device 100-1. The mobile station device 200-2 estimates channels H₂₁, H₂₂, and H₂₃, the mobile station device 200-3 estimates channels H₃₁, H₃₂, and H₃₃, and the mobile station devices 200-2 and 200-3 quantize and feed back the channel estimation values to the respective base station devices to which the mobile station devices are connected.

The base station device 100-1 obtains channel state information transmitted from the mobile station device 200-2 and the mobile station device 200-3, by using backhaul lines, calculates a weighting factor that is used to eliminate inter-cell interference imposed on the mobile station device 200-2 and the mobile station device 200-3, and transmits a signal obtained by multiplying information data by the weighting factor to the mobile station device 200-1. As a result, the base station device 100-1 attains directivity to the mobile station device 200-1. Similarly, the base station device 100-2 and the base station device 100-3 transmit signals obtained by performing multiplication by respective weighting factors that are used to eliminate inter-cell interference imposed on mobile station devices that are connected to base station devices in other cells. As described above, in a coordinated control technique, base station devices share channel state information fed back from mobile station devices and perform multiplication by respective weighting factors that are used to suppress inter-cell interference, thereby making it possible to suppress inter-cell interference.

### CITATION LIST

### Non Patent Literature

NPL 1: 3rd Generation Partnership Project; Technical Specification Group Radio Access Network; Further Advancements for E-UTRA Physical Layer Aspects (Release 9), 3GPP TR 36.814 V9.0.0 (2010-03), March 2010, URL: http://www.3gpp.org/ftp/Specs/html-info/36814.htm

### SUMMARY OF INVENTION

### Technical Problem

Each mobile station device quantizes each channel estimation value using the number of channel bits that has been determined for feedback, and generates channel state information. Here, the number of channel bits is the number of bits of channel state information per channel Hₖⱼ. FIG. 3 includes diagrams illustrating examples of the amplitude values of channel estimation values Ĥₖⱼ, where FIG. 3(A) illustrates the amplitude values of Ĥ₁₁, FIG. 3(B) illustrates the amplitude values of Ĥ₁₂, and FIG. 3(C) illustrates the amplitude values of Ĥ₁₃. For example, in a case where it is assumed that the number of channel bits is 3000 bits, the number of quantization bits per subcarrier is 10 bits, which is obtained by dividing 3000 bits by 300 subcarriers, and therefore, each amplitude value is quantized into 10 bits, as illustrated in FIG. 4. As described above, the same quantization is performed on all channel estimation values so that the number of channel bits is 3000 in FIG. 4, and therefore, the amount of information contained in channel state information regarding the channel estimation value (Ĥ₁₁) relating to a desired signal and the amount of information contained in channel state information regarding each of the channel estimation values (Ĥ₁₂ and Ĥ₁₃) relating to inter-cell interference are the same. Accordingly, the amount of information contained in each piece of channel state information decreases as a result of quantization, and the feedback accuracy decreases. In a coordinated control technique, particularly in a case where the feedback accuracy regarding channel state information relating to inter-cell interference is low, the calculation accuracy of a weighting factor that is used to suppress inter-cell interference decreases, resulting in insufficient suppression of inter-cell interference, which has been a problem.

The present invention has been made in view of the above-described situation, and an object thereof is to provide a communication system, a communication method, a base station device, and a mobile station device for attaining a high degree of interference suppression effect in a communication system in which communication is performed among base station devices in a coordinated manner.

### Solution to Problem

A communication system according to one aspect of the present invention is a communication system including a plurality of base station devices and a mobile station device that is connected to at least one of the plurality of base station devices, the plurality of base station devices being disposed such that cells that are connectable areas of the base station devices entirely or partially overlap. The mobile station device generates a first channel estimation value of a channel between the mobile station device and a base station device to which the mobile station device is connected, and a second channel estimation value of a channel between the mobile station device and a base station device other than the base station device to which the mobile station device is connected; generates first channel state information and second channel state information using an identical number of channel bits while making an amount of information contained in the second channel state information larger than an amount of information contained in the first channel state information, the first channel state information being used to transmit the first channel estimation value to a base station device, the second channel state information being used to transmit the second channel estimation value to a base station device; and transmits the first channel state information and the second channel state information to the base station device to which the mobile station device is connected. A base station device other than a main base station device among the plurality of base station devices transmits the first channel state information and the second channel state information to the main base station device in a case of receiving the first channel state information and the second channel state information. The master base station device calculates a transmission weight used in coordinated control performed by the base station devices, by using the first channel state information and the second channel state information.

In the communication system according to the present invention, the master base station device further calculates a reception weight used by each mobile station device, and the mobile station device performs demodulation using the reception weight.

In the communication system according to the present invention, the mobile station device includes a first quantization unit that generates the first channel state information and a second quantization unit that generates the second channel state information. The first quantization unit performs a quantization process of calculating a first number of quantization bits so as to make a product of the first number of quantization bits and a number of subcarriers equal to or less than the number of channel bits, and quantizing first channel estimation values for respective subcarriers by using the first number of quantization bits. The second quantization unit performs a quantization process of assuming a second channel estimation value relating to a subcarrier as a reference value, quantizing the reference value by using the first number of quantization bits, calculating differences between the reference value and second channel estimation values other than the reference value for the respective subcarriers, and quantizing the differences for the respective subcarriers by using the first number of quantization bits.

In the communication system according to the present invention, the second quantization unit makes a third number of quantization bits used in quantizing a value other than the reference value less than a second number of quantization bits used in quantizing the reference value.

In the communication system according to the present invention, the second quantization unit quantizes a difference between a second channel estimation value relating to a subcarrier and a second channel estimation value relating to a contiguous subcarrier by using the first number of quantization bits.

In the communication system according to the present invention, the second quantization unit includes an IFFT unit, a time filter unit, and a third quantization unit. The IFFT unit converts the second channel estimation values for the respective subcarriers into impulse responses for respective paths. The time filter unit extracts paths within a predetermined range from the impulse responses. The third quantization unit calculates a fourth number of quantization bits so as to make a product of a number of paths that have been extracted and the fourth number of quantization bits equal to or less than the number of channel bits, and quantizes the impulse responses by using the fourth number of quantization bits.

In the communication system according to the present invention, the plurality of base station devices obtain the first channel estimation value and the second channel estimation value in accordance with the quantization process performed by the first quantization unit of the mobile station device and the quantization process performed by the second quantization unit of the mobile station device.

A communication method according to the present invention is a communication method for a communication system including a plurality of base station devices and a mobile station device that is connected to at least one of the plurality of base station devices, the plurality of base station devices being disposed such that cells that are connectable areas of the base station devices entirely or partially overlap. The mobile station device generates a first channel estimation value of a channel between the mobile station device and a base station device to which the mobile station device is connected, and a second channel estimation value of a channel between the mobile station device and a base station device other than the base station device to which the mobile station device is connected; generates first channel state information and second channel state information using an identical number of channel bits while making an amount of information contained in the second channel state information larger than an amount of information contained in the first channel state information, the first channel state information being used to transmit the first channel estimation value to a base station device, the second channel state information being used to transmit the second channel estimation value to a base station device; and transmits the first channel state information and the second channel state information to the base station device to which the mobile station device is connected. A base station device other than a main base station device among the plurality of base station devices transmits the first channel state information and the second channel state information to the main base station device in a case of receiving the first channel state information and the second channel state information. The master base station device calculates a transmission weight used in coordinated control performed by the base station devices, by using the first channel state information and the second channel state information.

The base station device according to the present invention is used in the above-described communication system.

The mobile station device according to the present invention is used in the above-described communication system.

### Advantageous Effects of Invention

According to the present invention, in a system in which communication is performed among base station devices in a coordinated manner, a mobile station device efficiently transmits channel state information to a base station device to thereby attain a high degree of interference suppression effect, which is an advantageous effect.

### BRIEF DESCRIPTION OF DRAWINGS

FIG. 1 is a schematic diagram illustrating an example of a configuration of a communication system.

FIG. 2 is a diagram illustrating the definitions of downlink channels (transfer functions) in the communication system in FIG. 1.

FIG. 3 includes diagrams illustrating examples of the amplitude values of channel estimation values Ĥₖⱼ.

FIG. 4 includes diagrams illustrating examples of quantized amplitude values relative to those in FIG. 3.

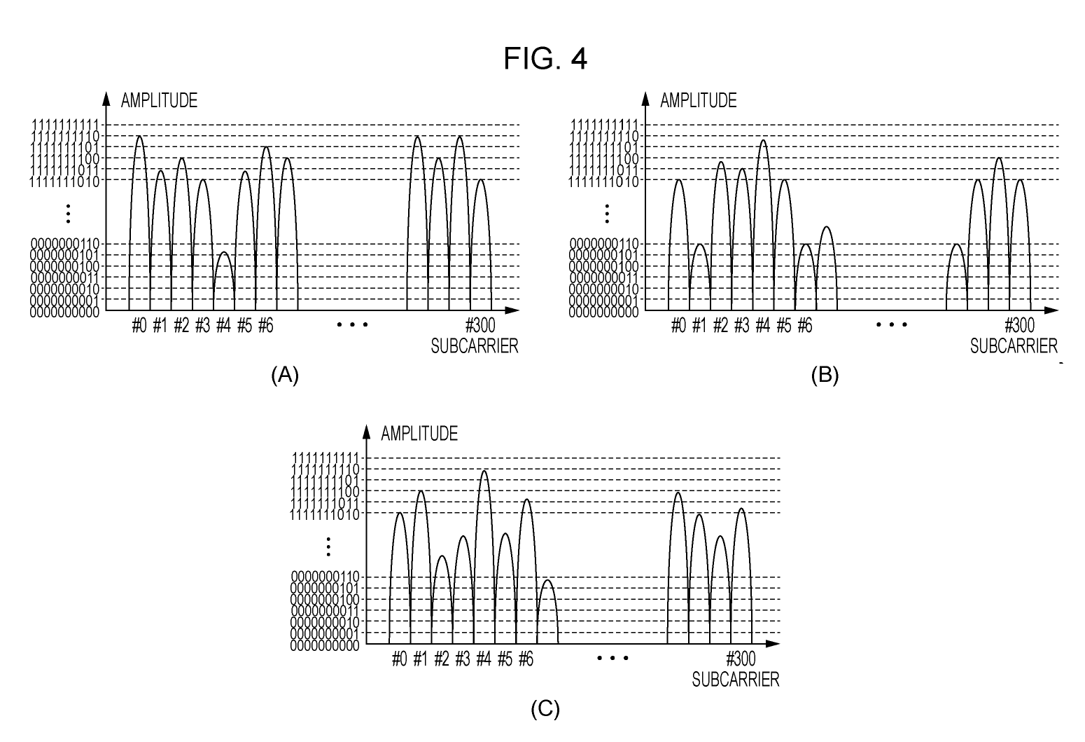

FIG. 5 is a schematic diagram illustrating an example of a configuration of a communication system having partially overlapping communication service areas.

FIG. 6 is a schematic block diagram illustrating an example of a configuration of a master base station device (base station device 100-1) in the communication system according to a first embodiment.

FIG. 7 is a flowchart illustrating an example of a process performed by a weighting factor calculation unit 105 to calculate a transmission weighting factor Vⱼ and a reception weighting factor Uₖ.

FIG. 8 is a schematic block diagram illustrating an example of a configuration of slave base station devices (a base station device 100-2 and a base station device 100-3) in the communication system according to the first embodiment.

FIG. 9 is a schematic block diagram illustrating an example of a configuration of a mobile station device 200-k in the communication system according to the first embodiment.

FIG. 10 is a schematic block diagram illustrating an example of a configuration of a feedback information generation unit 207 of the mobile station device 200-k in the communication system according to the first embodiment.

FIG. 11 includes diagrams illustrating an example of a process performed by a quantization unit 207-1 of the feedback information generation unit 207 of the mobile station device 200-k in the communication system according to the first embodiment.

FIG. 12 includes diagrams illustrating an example of a process performed by a quantization unit 207-2 of the feedback information generation unit 207 of the mobile station device 200-k in the communication system according to the first embodiment.

FIG. 13 is a sequence chart illustrating an example of operations among base station devices and a mobile station device in the communication system according to the embodiment.

FIG. 14 is a schematic block diagram illustrating an example of a configuration of the feedback information generation unit 207 of the mobile station device 200-k in a communication system according to a second embodiment.

FIG. 15 includes diagrams illustrating an example of a quantization process for quantizing channel estimation values relating to inter-cell interference according to the second embodiment.

### DESCRIPTION OF EMBODIMENTS

### First Embodiment

Regarding a communication system 1 according to a first embodiment, an example will be described in which a base station device 100-j and a mobile station device 200-k perform data transmission using an OFDM (Orthogonal Frequency Division Multiplexing) scheme. Note that this embodiment is not limited to this example, and other transmission schemes may be used, such as a single carrier transmission scheme based on SC-FDMA (Single Carrier-Frequency Division Multiple Access), DFT-s-OFDM (Discrete Fourier Transform-spread-OFDM), or the like, or a multicarrier transmission scheme based on MC-CDMA (Multiple Carrier-Code Division Multiple Access) or the like, for example. Examples of the communication system 1 according to the first embodiment include wireless communication systems based on WCDMA (registered trademark) (Wideband Code Division Multiple Access), LTE (Long Term Evolution), or LTE-A (LTE-Advanced) developed by the 3GPP (Third Generation Partnership Project) or WiMAX (Worldwide Interoperability for Microwave Access) developed by IEEE (The Institute of Electrical and Electronics Engineers), but are not limited to these systems.

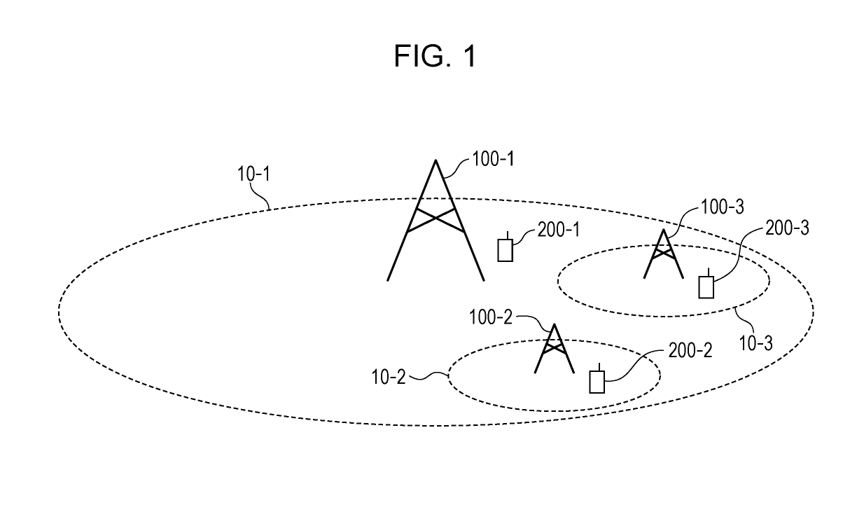

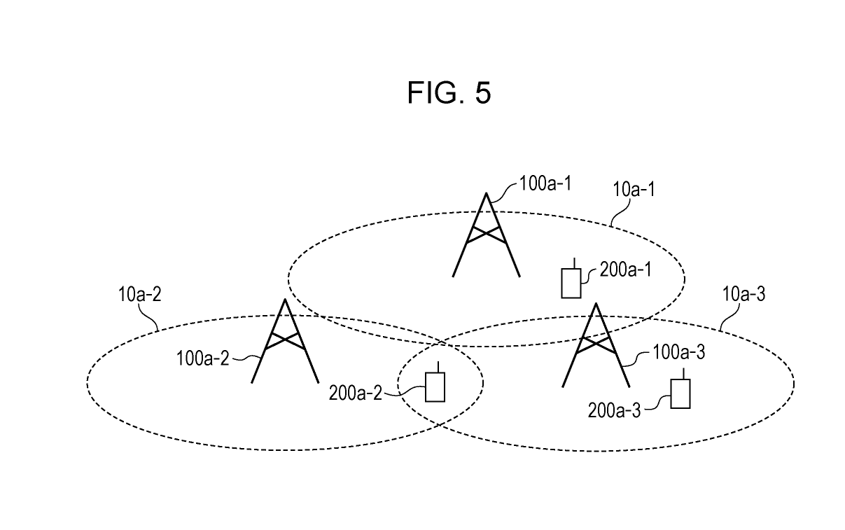

An example of a configuration of the communication system according to the first embodiment is similar to that in FIG. 1. FIG. 5 is a schematic diagram illustrating an example of a configuration of a communication system having partially overlapping communication service areas, and the communication system configuration in FIG. 5 may be assumed in this embodiment. In FIG. 5, there are three cells 10a-j (j is any positive integer, where 1≦j≦3 in FIG. 5), the communication service areas of which partially overlap. To each base station device 100a-j in each cell, one mobile station device 200a-k (k is any positive integer, where 1≦k≦3 in FIG. 5) is connected, and the mobile station device 200a-k is connected to a base station device 100a-j, where k=j. The base station devices are connected to one another via backhaul lines. Note that, in the communication systems illustrated in FIGS. 1 and 5, the number of cells, the number of base station devices, the number of mobile station devices, a method for connecting backhaul lines between base station devices, and the like are not limited to those described above.

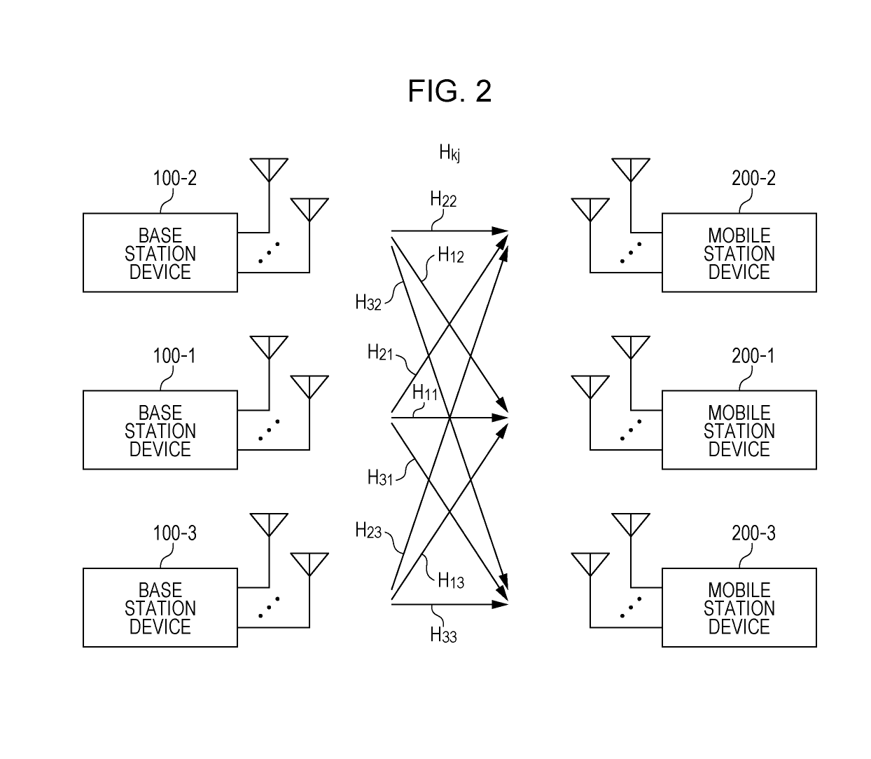

The definitions of downlink channels in the communication system according to the first embodiment are similar to those in FIG. 2. In FIG. 2, for the mobile station device 200-k, a signal transmitted by the base station device 100-j, where k=j, is a desired signal. For the mobile station device 200-k, a signal transmitted by the base station device 100-j, where k≠j, causes inter-cell interference. For example, for a mobile station device 200-1, a transmission signal from a base station device 100-1 which is received via a channel H₁₁ is a desired signal, and transmission signals from a base station device 100-2 and a base station device 100-3 which are respectively received via a channel H₁₂ and a channel H₁₃ cause inter-cell interference (are undesired signals).

In this embodiment, an IA (Interference Alignment) scheme is used, for example, as a coordinated control technique. An IA scheme is a scheme in which base station devices in a plurality of cells and mobile station devices coordinate with one another and use transmission weights and reception weights so as to suppress inter-cell interference to be imposed on one another. Note that a coordinated control technique in this embodiment is not limited to an IA scheme, and a scheme for suppressing inter-cell interference using only transmission weights (for example, an SLNR (Signal to Leakage plus Noise Ratio) scheme) or the like may be used.

Hereinafter, the base station device 100-1 is assumed to be a main base station device (master base station device) that calculates a transmission weighting factor Vⱼ and a reception weighting factor Uₖ, and the base station device 100-2 and the base station device 100-3 are assumed to be subordinate base station devices (slave base station devices) that operate in a coordinated manner in accordance with instructions given by the master base station device. Note that examples of slave base station devices include any devices that can perform processes for implementing the present invention, such as a relay station device, an access point (AP), and the like.

The communication system and the definitions of channels in this embodiment are applicable to other embodiments.

[Master Base Station Device]

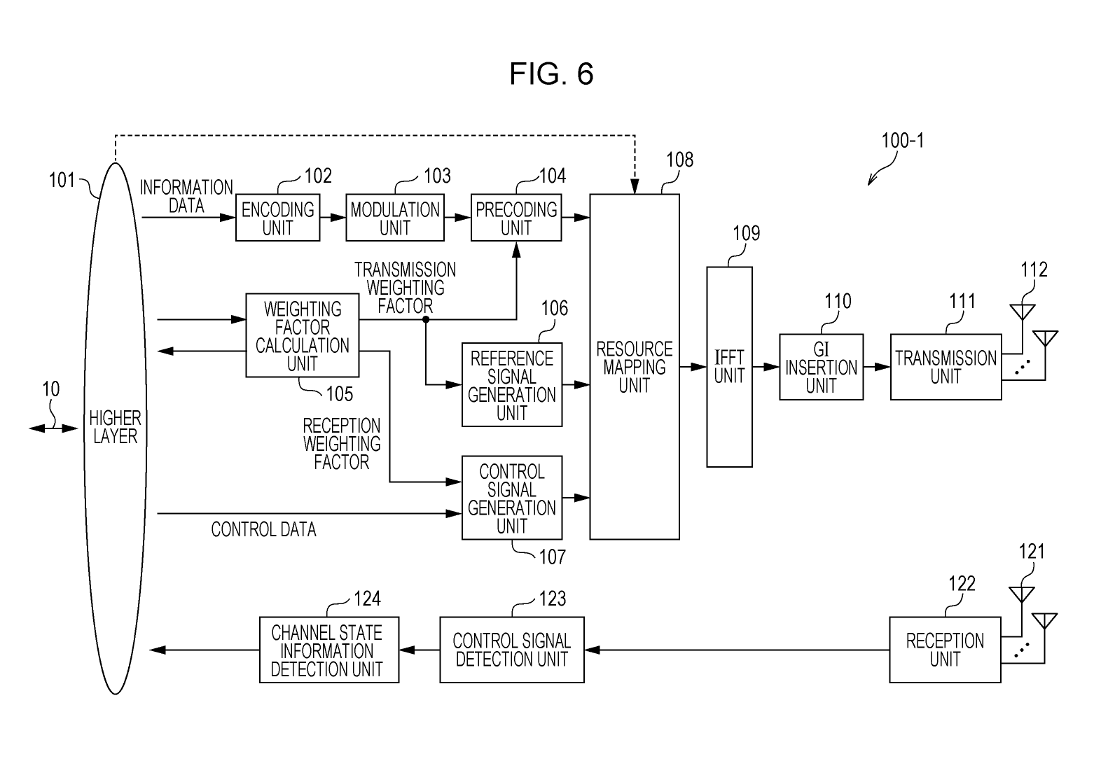

FIG. 6 is a schematic block diagram illustrating an example of a configuration of the master base station device (base station device 100-1) in the communication system according to the first embodiment.

The master base station device (base station device 100-1) includes a higher layer 101, an encoding unit 102, a modulation unit 103, a precoding unit 104, a weighting factor calculation unit 105, a reference signal generation unit 106, a control signal generation unit 107, a resource mapping unit 108, an IFFT unit 109, a GI insertion unit 110, a transmission unit 111, a transmission antenna unit 112, a reception antenna unit 121, a reception unit 122, a control signal detection unit 123, and a channel state information detection unit 124. The master base station device (base station device 100-1) is connected to the slave base station devices (base station device 100-2 and base station device 100-3) via backhaul lines 10. Note that, in a case where part or all of the base station device 100-1 is integrated into a chip so as to form an integrated circuit, a chip control circuit (not illustrated) that performs control on individual functional blocks is included.

In the uplink, the base station device 100-1 receives signals transmitted by the mobile station device 200-1, via the reception antenna unit 121. The base station device 100-1 receives signals including control signals that contain channel state information (CSI: Channel Statement Information). The channel state information is also called explicit channel state information (explicit CSI).

The control signal may contain information regarding parameters of a transmission signal that is transmitted by the base station device in the downlink. A channel quality indicator (CQI), the rank count and spatial multiplexing count in MIMO transmission (RI: Rank Indicator), other information relating to downlink scheduling, and the like correspond to the information regarding parameters of a transmission signal. Scheduling is to determine at what time (timing) transmission is performed using what frequency band in a case of transmitting certain data, and scheduling information is information regarding the time and frequency band thus determined. For example, in LTE and LTE-A, scheduling is to determine to what resource block information data or the like is allocated. Note that a resource block in OFDM transmission is a unit of signal allocation, which is formed by putting together a plurality of resource elements, a resource element being a minimum unit to which a signal formed of one subcarrier and one OFDM symbol is allocated.

The reception unit 122 down-converts the control signal and the like into a signal of a frequency band on which a digital signal process, such as a signal detection process, can be performed (performs radio frequency conversion), performs a filtering process, and converts the signal, on which the filtering process has been performed and which is an analog signal, into a digital signal (performs A/D conversion: analog-to-digital conversion).

The control signal detection unit 123 performs a demodulation process, a decoding process, and the like on signals output by the reception unit 122, and detects a control signal. A control signal is detected from an uplink control channel (PUCCH: Physical Uplink Control Channel), an uplink shared channel (PUSCH: Physical Uplink Shared Channel), and the like.

The channel state information detection unit 124 converts each piece of channel state information relating to inter-cell interference among pieces of channel state information contained in control signals input from the control signal detection unit 123 into channel state information for each subcarrier, in accordance with a quantization process performed by a feedback information generation unit 207 of the mobile station device 200-k, which will be described below. Specifically, in a case where a quantization unit 207-2 has quantized a difference between amplitude values (amplitude difference) for each subcarrier, the higher layer 101 performs a process for converting the amplitude difference into an amplitude value.

The higher layer 101 obtains channel state information (channel state information relating to a desired signal) contained in a control signal input from the control signal detection unit 123, and obtains channel state information (channel state information relating to inter-cell interference) input from the channel state information detection unit 124. The pieces of channel state information described above are channel state information fed back by the mobile station device 200-1 that is connected to the base station device 100-1. Specifically, the higher layer 101 obtains channel state information regarding a channel between the base station device 100-1 and the mobile station device 200-1 (information regarding the channel H₁₁) from the control table method detection unit 123, and obtains channel state information regarding a channel between the base station device 100-2 and the mobile station device 200-1 (information regarding the channel H₁₂) and channel state information regarding a channel between the base station device 100-3 and the mobile station device 200-1 (information regarding the channel H₁₃) from the channel state information detection unit 124.

Note that the higher layer 101 can obtain information regarding parameters of a transmission signal (a CQI, an RI, other information relating to scheduling, and the like), which is contained in a control signal input from the control signal detection unit 123. Examples of the information regarding parameters of a transmission signal include information used in scheduling of a signal to be transmitted to a mobile station device that is connected to the base station device 100-1.

Here, a layer corresponding to a function higher than the physical layer among the layers of the communication functions defined in the OSI reference model, such as a data link layer (for example, the MAC (Media Access Control) layer), a network layer (for example, the RRC (Radio Resource Control) layer), or the like corresponds to the higher layer.

The higher layer 101 obtains channel state information from the slave base station devices (base station device 100-2 and base station device 100-3) via the backhaul lines 10. Specifically, the higher layer 101 obtains information regarding the channel H₂₁, information regarding the channel H₂₂, and information regarding the channel H₂₃ from the base station device 100-2, and obtains information regarding the channel H₃₁, information regarding the channel H₃₂, and information regarding the channel H₃₃ from the base station device 100-3. As a result, the master base station device obtains channel state information from base station devices with which coordinate control is to be performed.

The higher layer 101 can obtain, from the slave base station devices (base station device 100-2 and base station device 100-3) via the backhaul lines 10, information regarding parameters of transmission signals (CQIs, RIs, other information relating to scheduling, and the like) which are transmitted by the slave base station devices in the downlink. The information regarding parameters of transmission signals is information that the slave base station devices have obtained from mobile station devices which are connected to the respective slave base station devices.

The higher layer 101 may include a scheduling unit (not illustrated) that performs scheduling regarding signals to be transmitted by the master base station device 100-1 and the slave base station devices, using the information regarding parameters of transmission signals (CQIs, RIs, other information relating to scheduling, and the like) which has been obtained. For example, in the communication system illustrated in FIG. 1, the scheduling unit can perform scheduling regarding a signal that the base station device 100-1 is to transmit to the mobile station device 200-1 which is connected to the base station device 100-1, a signal that the base station device 100-2 is to transmit to the mobile station device 200-2 which is connected to the base station device 100-2, and a signal that the base station device 100-3 is to transmit to the mobile station device 200-3 which is connected to the base station device 100-3. Note that scheduling regarding signals that slave base station devices are to transmit to mobile station devices which are connected to the respective salve base station devices may be individually performed by the respective slave base station devices. In such a case, the slave base station devices transmit the results of the scheduling to the master base station device.

The higher layer 101 inputs the channel state information that has been obtained to the weighting factor calculation unit 105. Here, the higher layer 101 may be configured to input information regarding base station devices with which coordination is to be performed (for example, IDs of the base station devices with which coordination is to be performed, the number of base station devices and the number of mobile station devices with which coordination is to be performed, and the like) and the results of the scheduling, to the weighting factor calculation unit 105. The higher layer 101 may transmit the information regarding parameters of transmission signals (CQIs, RIs, other information relating to scheduling, and the like) to the weighting factor calculation unit 105.

The higher layer 101 transmits transmission weighting factors or/and reception weighting factors calculated by the weighting factor calculation unit 105, which will be described below, to the slave base station devices via the backhaul lines 10. The higher layer 101 of the base station device 100-1 transmits, to the base station device 100-2 via a backhaul line 10-1, a transmission weighting factor V₂ by which the base station device 100-2 multiplies a transmission signal or/and a reception weighting factor U₂ by which the mobile station device 200-2 multiplies a reception signal. The higher layer 101 of the base station device 100-1 transmits, to the base station device 100-3 via a backhaul line 10-2, a transmission weighting factor V₃ by which the base station device 100-3 multiplies a transmission signal and a reception weighting factor U₃ by which the mobile station device 200-3 multiplies a reception signal. Note that, while it is assumed in this embodiment that the weighting factor calculation unit 105 calculates a transmission weighting factor and a reception weighting factor, a reception weighting factor Uₖ is not transmitted in a case where only a transmission weighting factor is calculated.

The higher layer 101 outputs information data to the encoding unit 102, and outputs control data to the control signal generation unit 107.

Note that the higher layer 101 also transmits other parameters necessary for each unit that forms the base station device 100-1 to implement its function.

The encoding unit 102 performs error correction coding on the information data input from the higher layer 101. Examples of information data include a sound signal associated with a call, a still image signal or a moving image signal that represents a captured image, and a text message. A coding scheme that the encoding unit 102 uses when performing error correction coding is turbo coding, convolutional coding, or low density parity check coding (LDPC), for example. Note that the encoding unit 102 may perform a rate matching process on a coded bit sequence in order to match the coding rate of a data sequence on which error correction coding has been performed with a coding rate corresponding to the data transmission rate. The encoding unit 102 may have a function of rearranging and interleaving a data sequence on which error correction coding has been performed.

The modulation unit 103 modulates a signal input from the encoding unit 102, and generates a modulation symbol. A modulation process performed by the modulation unit 103 is based on BPSK (Binary Phase Shift Keying), QPSK (Quadrature Phase Shift Keying), or QAM (Quadrature Amplitude Modulation), for example. Note that the modulation unit 103 may have a function of rearranging and interleaving modulation symbols that have been generated.

The weighting factor calculation unit 105 calculates a transmission weighting factor Vⱼ by which the master base station device and the slave base station devices multiply signals to be transmitted and a reception weighting factor Uₖ by which the mobile station devices which are connected to the respective base station devices multiply reception signals, by using channel state information obtained from the higher layer 101. That is, the weighting factor calculation unit 105 calculates a transmission weighting factor and a reception weighting factor by using pieces of channel state information relating to all base stations that perform coordinated control.

The weighting factor calculation unit 105 transmits to the higher layer 101 the transmission weighting factor Vⱼ for the slave base station devices and the reception weighting factor Uₖ for the mobile station devices which are connected to the respective slave base station devices.

The weighting factor calculation unit 105 outputs a transmission weighting factor V₁ by which a transmission signal of the master base station device (base station device 100-1) is multiplied, to the precoding unit 104. The weighting factor calculation unit 105 outputs a reception weighting factor U₁ for the mobile station device which is connected to the master base station device (base station device 100-1), to the control signal generation unit 107.

Note that, while it is assumed in this embodiment that the weighting factor calculation unit 105 calculates a transmission weighting factor and a reception weighting factor, the reception weighting factor Uₖ is not transmitted in a case where only a transmission weighting factor is calculated.

The precoding unit 104 multiplies the modulation symbol output by the modulation unit 103 by the transmission weighting factor V₁.

The reference signal generation unit 106 generates a reference signal (pilot signal), and outputs the generated reference signal to the resource mapping unit 108. A reference signal is a signal used to estimate the channel performance of channels from the transmission antenna unit 112 of the base station device to reception antenna units 201-1 and 201-2 of respective mobile station devices. The estimated channel performance is used for channel state information that is used to calculate a transmission weighting factor and a reception weighting factor, or is used in channel compensation in the mobile station devices.

The control signal generation unit 107 generates a control signal that contains the control data output by the higher layer 101 and the reception weighting factor U₁ (reception weighting factor for the mobile station device which is connected to the base station device 100-1) output by the weighting factor calculation unit 105. Note that error correction coding and a modulation process may be performed on the control signal.

The resource mapping unit 108 maps the modulation symbol, the reference signal, and the control signal onto resource elements (hereinafter referred to as resource mapping) on the basis of scheduling information transmitted from the higher layer 101.

The IFFT unit 109 performs fast Fourier transform (IFFT: Inverse Fast Fourier Transform) on a frequency domain signal input from the resource mapping unit 108, and converts the frequency domain signal into a time domain signal. The IFFT unit 109 may use other processing methods (for example, inverse discrete Fourier transform (IDFT)) instead of IFFT as long as a frequency domain signal can be converted into a time domain signal.

The GI insertion unit 110 adds a GI (a guard interval, also called a guard section) to the time domain signal (also called an effective symbol) input from the IFFT unit 109, and generates an OFDM symbol. A GI is a section that is added in order to suppress interference between a previous OFDM symbol and a succeeding OFDM symbol. For example, the GI insertion unit 110 uses a replica (copy) of a partial section in the latter half of an effective symbol as a GI, and adds the GI in front of the effective symbol. Accordingly, the effective symbol including a GI in front of the effective symbol forms an OFDM symbol.

The transmission unit 111 converts the OFDM symbol input from the GI insertion unit 110, which is a digital signal, into an analog signal (performs D/A conversion: digital-to-analog conversion).

The transmission unit 111 performs a filtering process on the generated analog signal, and generates a band-limited signal by limiting the band. The transmission unit 111 up-converts the generated band-limited signal into a signal of a radio frequency band, and outputs the resulting signal to the transmission antenna unit 112.

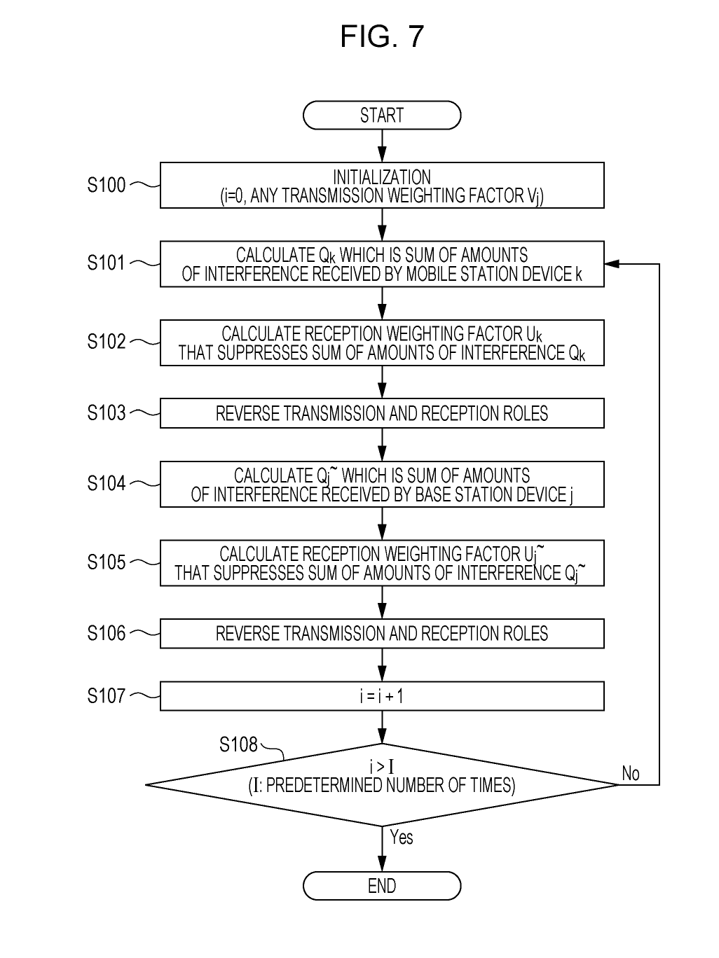

Next, a process performed by the master base station device to calculate the transmission weighting factor Vⱼ and the reception weighting factor Uₖ will be described. FIG. 7 is a flowchart illustrating an example of a process performed by the weighting factor calculation unit 105 to calculate the transmission weighting factor Vⱼ and the reception weighting factor Uₖ.

In step S100, a counter i is initialized to 0. Any initial value is set for the transmission weighting factor Vⱼ.

In step S101, Qₖ, which is the sum of the amounts of interference in the mobile station device 200-k, is calculated on the basis of expression (1). Here, Q represents a covariance matrix of received interference signals. P represents a transmission power, K represents the number of mobile station devices that are targets of coordinated control, and Hₖⱼ represents channel state information retained by the higher layer 101. ^{H} represents complex conjugate transposition.

$$\begin{matrix}[ Math . 1 ] & \\ {Q}_{k} = {\sum }_{j = 1 , j \neq k}^{K} \frac{{P}_{j}}{{d}_{j}} {H}_{kj} {V}_{j} {V}_{j}^{H} {H}_{kj}^{H} & ( 1 )\end{matrix}$$

In step S102, singular value decomposition is performed on the sum of the amounts of interference Qₖ that has been calculated, and the reception weighting factor Uₖ that suppresses the sum of the amounts of interference Qₖ is calculated. Note that, in steps S102 and S103, the reception weighting factor Uₖ is calculated in a case where the mobile station device 200-k receives a transmission signal from the base station device 100-j.

In step S103, the transmission role and the reception role are reversed in the base station device 100-j and in the mobile station device 200-k. That is, in a case where the base station device 100-j receives a signal obtained by the mobile station device 200-k multiplying a transmission signal by the reception weighting factor Uₖ, a reception weighting factor Uₖ˜ for the base station device 100-j is calculated. Consequently, the reception weighting factor Uₖ˜ corresponds to the transmission weighting factor Vₖ for the base station device 100-j. Specifically, substitution, Hⱼₖ˜=Hₖⱼ^{H} and Vₖ˜=Uₖ, is performed in step S103.

In step S104, Qⱼ˜, which is the sum of the amounts of interference in the base station device 100-j, is calculated on the basis of expression (2).

$$\begin{matrix}[ Math . 2 ] & \\ {\tilde{Q}}_{j} = {\sum }_{k = 1 , k \neq j}^{K} \frac{{\tilde{P}}_{k}}{{d}_{k}} {\tilde{H}}_{jk} {\tilde{V}}_{k} {\tilde{V}}_{k}^{H} {\tilde{H}}_{jk}^{H} & ( 2 )\end{matrix}$$

In step S105, singular value decomposition is performed on the sum of the amounts of interference Qⱼ˜, and a reception weighting factor Uⱼ˜ that suppresses the sum of the amounts of interference Qⱼ˜ is calculated.

In step S106, the transmission role and the reception role are reversed again in the base station device 100-j and in the mobile station device 200-k. That is, substitution Vⱼ=Uⱼ˜ is performed.

In step S107, the counter i for counting the number of processes performed is incremented by one.

In step S108, the value of the counter i is compared with a predetermined number of times I. If the value of the counter i does not reach the predetermined number of times I (No in step S108), the process from step S101 to step S107 is repeated. On the other hand, if the value of the counter i reaches the predetermined number of times I (Yes in step S108), the process ends, and the transmission weighting factor Vⱼ for the base station device 100-j is assumed to be the reception weighting factor Uₖ for the mobile station device 200-k. Note that the predetermined number of times I is the number of repetitions of the algorithm in FIG. 7, and is set to any number in advance.

As described above, the reception weighting factors (Uₖ and Uⱼ˜) for reducing an interference power are repeatedly updated while the transmission role and the reception role are reversed in the base station device 100-j and in the mobile station device 200-k to thereby obtain weighting factors that allow the base station device 100-j and the mobile station device 200-k to suppress the impact of interference. Note that the above-described calculation method is merely an example, and the calculation method is not limited to that described above. Other calculation methods may be used.

[Slave Base Station Device]

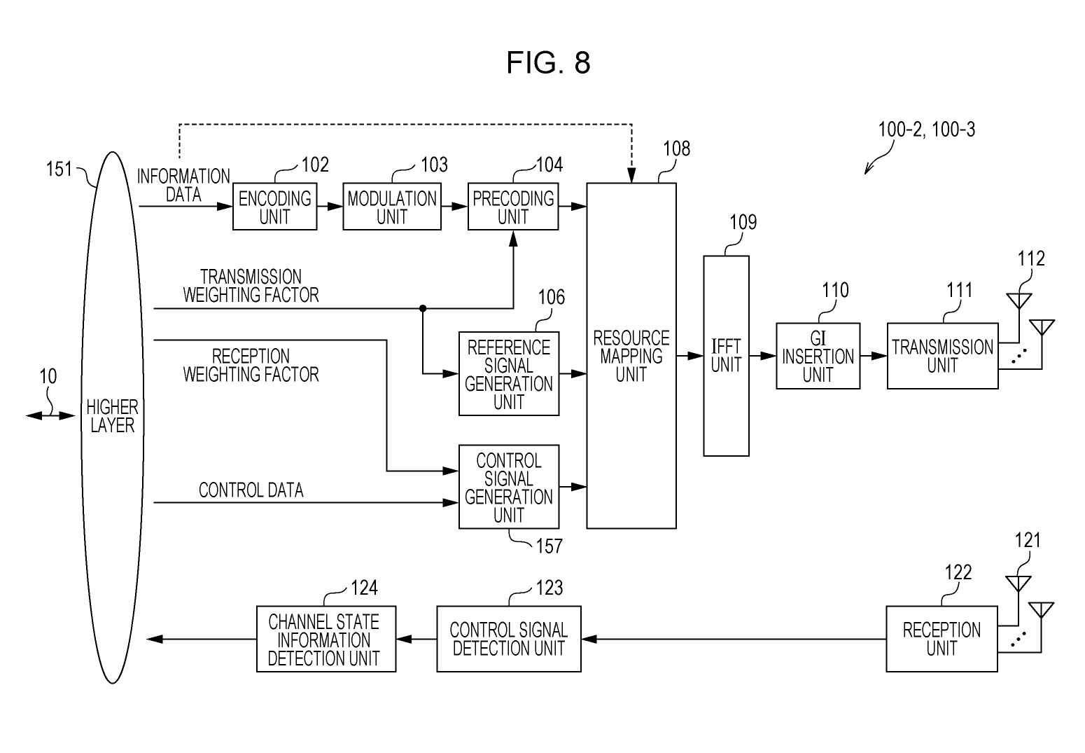

FIG. 8 is a schematic block diagram illustrating an example of a configuration of the slave base station devices (base station device 100-2 and base station device 100-3) in the communication system according to the first embodiment. While a configuration of the base station device 100-2 will be described below, the base station device 100-3 also has a similar configuration.

The base station device 100-2 includes a higher layer 151, the encoding unit 102, the modulation unit 103, the precoding unit 104, the reference signal generation unit 106, a control signal generation unit 157, the resource mapping unit 108, the IFFT unit 109, the GI insertion unit 110, the transmission unit 111, the transmission antenna unit 112, the reception antenna unit 121, the reception unit 122, and the control signal detection unit 123. The slave base station devices (base station device 100-2 and base station device 100-3) are connected to the master base station device (base station device 100-1) via the backhaul lines 10. Note that, in a case where part or all of the base station device 100-2 is integrated into a chip so as to form an integrated circuit, a chip control circuit (not illustrated) that performs control on individual functional blocks is included.

Although the master base station device obtains channel state information from another base station device and calculates a weighting factor, the slave base station devices do not perform such a process. Accordingly, the slave base station device (FIG. 8) has a configuration obtained by excluding the weighting factor calculation unit 105 from the configuration of the master base station device (FIG. 6). The higher layer 151 and the control signal generation unit 157 in FIG. 8 perform processes different from those performed by the higher layer 101 and the control signal generation unit 106 in FIG. 6. Hereinafter, portions in FIG. 8 which are different from FIG. 6 will be mainly described with reference to FIG. 8. Note that, while description of the base station device 100-2 will be given below, the base station device 100-3 is similar to the base station device 100-2.

The higher layer 151 obtains channel state information (channel state information relating to a desired signal) contained in a control signal input from the control signal detection unit 123, and obtains channel state information (channel state information relating to inter-cell interference) input from the channel state information detection unit 124. Specifically, the higher layer 151 obtains channel state information (information regarding the channel H₂₂) contained in a control signal input from the control signal detection unit 123, and channel state information (information regarding the channel H₂₁ and information regarding the channel H₂₃) input from the channel state information detection unit 124.

The higher layer 151 transmits the pieces of channel state information to the master base station device 100-1 via the backhaul line 10.

The higher layer 151 can transmit, to the master base station device 100-1 via the backhaul line 10, information regarding parameters of a transmission signal (a CQI, an RI, other information relating to scheduling, and the like) which is transmitted by the slave base station device 100-2 in the downlink. The information regarding parameters of a transmission signal is information that the slave base station device has obtained from a mobile station device which is connected to the slave base station device.

The higher layer 151 can schedule determination or the like of an MCS for a transmission signal to be transmitted to a mobile station device that is connected to itself, that is, the base station device 100-2, and a resource block to which the transmission signal is to be allocated, on the basis of the information regarding parameters of the transmission signal (a CQI, an RI, other information relating to scheduling, and the like). In this case, the higher layer 151 transmits the result of the scheduling to the master bases station device 100-1 via the backhaul line 10.

The higher layer 151 obtains, from the master base station device via the backhaul line 10, the transmission weighting factor V₂ by which the base station device 100-2 multiplies a transmission signal of the base station device 100-2 and the reception weighting factor U₂ for the mobile station device 200-2 that is connected to the base station device 100-2.

The higher layer 151 inputs the transmission weighting factor V₂ to the precoding unit 104. The higher layer 151 inputs the reception weighting factor U₂ to the control signal generation unit 157.

The precoding unit 104 multiplies a modulation symbol output by the modulation unit 103 by the transmission weighting factor V₂.

The control signal generation unit 157 generates a control signal that contains control data and the reception weighting factor U₂ (reception weighting factor for the mobile station device 200-2 that is connected to the base station device 100-2) output by the higher layer 151.

[Mobile Station Device]

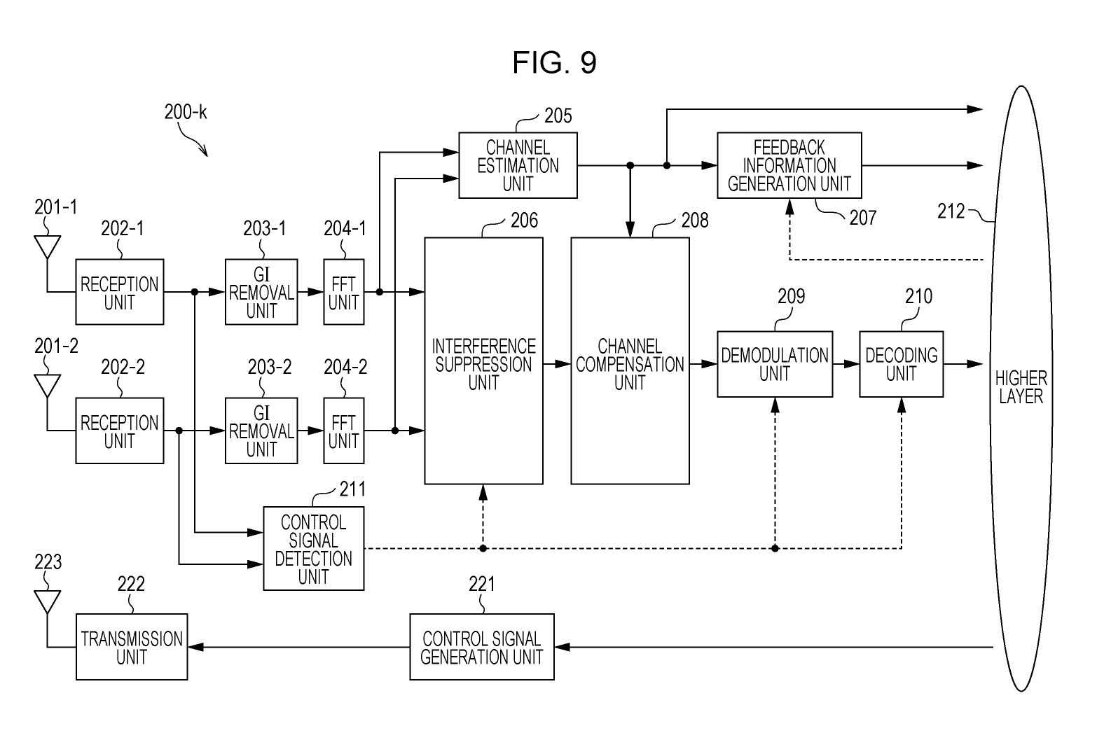

FIG. 9 is a schematic block diagram illustrating an example of a configuration of the mobile station device 200-k in the communication system according to the first embodiment.

The mobile station device 200-k includes a plurality of reception antenna units 201-e, a plurality of reception units 202-e, a plurality of GI removal units 203-e, a plurality of FFT units 204-e, a channel estimation unit 205, an interference suppression unit 206, the feedback information generation unit 207, a channel compensation unit 208, a demodulation unit 209, a decoding unit 210, a higher layer 212, a control signal detection unit 211, a control signal generation unit 221, a transmission unit 222, and a transmission antenna unit 223. Note that e represents the number of reception antennas of the mobile station device. FIG. 9 illustrates an example in which the mobile station device 200-k has two (e=2) reception antennas; however, the number of antennas is not limited to two, and any number of antennas may be provided. In FIG. 9, there is one transmission antenna 223; however, the number of transmission antennas is not limited to one. A plurality of transmission antennas may be provided, or an antenna may be configured as a transmission antenna and a reception antenna. In a case where part or all of the mobile station device 200-k is integrated into a chip so as to form an integrated circuit, a chip control circuit (not illustrated) that performs control on individual functional blocks is included.

The mobile station device 200-k receives a signal transmitted from the base station device 100-j via the reception antenna unit 201-e. Here, in a case where a mobile station device 200-m (mεk, m is an element of k) is connected to the base station device 100-j, a signal transmitted by a base station device other than the base station device 100-j causes inter-cell interference for the mobile station device 200-m.

The reception unit 202-e down-converts a radio frequency signal input from the reception antenna unit 201-e into a signal of a frequency band on which a digital signal process can be performed, and further performs a filtering process on the down-converted signal. The reception unit 202-e performs A/D conversion on the signal on which the filtering process has been performed so as to convert from an analog signal to a digital signal, and outputs the converted digital signal to the GI removal unit 203-e and the control signal detection unit 211.

The GI removal unit 203-e removes a guard interval GI from the signal output from the reception unit 202-e in order to avoid distortion caused by a delay wave, and outputs a signal from which the guard interval has been removed to the FFT unit 204-e.

The FFT unit 204-e performs fast Fourier transform (FFT) on the signal input from the GI removal unit 203-e, from which the guard interval has been removed, so as to convert from a time domain signal to a frequency domain signal, and outputs the resulting signal to the channel estimation unit 205 and the interference suppression unit 206. Note that the FFT unit 204-e need not perform FFT, and may perform other methods, for example, discrete Fourier transform (DFT), as long as conversion from a time domain signal into a frequency domain signal can be attained.

The channel estimation unit 205 performs demapping on a pilot signal (reference signal) for channel estimation contained in the signal output by the FFT unit 204-e, and performs channel estimation by using the pilot signal. A channel estimation value is represented by a transfer function, for example. Specifically, the channel estimation unit 205 performs channel estimation on a channel between the mobile station device 200-k and a base station device to which the mobile station device 200-k is connected, by using a pilot signal transmitted by the base station device to which the mobile station device 200-k is connected. The channel estimation unit 205 performs channel estimation on a channel between the mobile station device 200-k and a base station device other than the base station device to which the mobile station device 200-k is connected, by using a pilot signal transmitted by the base station device other than the base station device to which the mobile station device 200-k is connected. The channel estimation unit 205 thereafter transmits, to the channel compensation unit 208 and the channel state information generation unit 207, the channel estimation value of the channel between the mobile station device 200-k and the base station device to which the mobile station device 200-k is connected. The channel estimation unit 205 transmits, to the channel state information generation unit 207, the channel estimation value of the channel between the mobile station device 200-k and the base station device other than the base station device to which the mobile station device 200-k is connected.

The channel estimation value of a channel between the mobile station device 200-k and the base station device 100-j, the channel estimation value being calculated by the channel estimation unit 205, is denoted by Ĥₖⱼ. Then, the channel estimation value is calculated on the basis of expression (3).

$$\begin{matrix}[ Math . 3 ] & \\ {\hat{H}}_{kj} = \frac{{H}_{kj} {S}_{j}}{{\tilde{S}}_{j}} & ( 3 )\end{matrix}$$

Here, Sⱼ represents a pilot signal transmitted by the base station device 100-j, and Sⱼ˜ represents a pilot signal transmitted by the base station device 100-j known to the mobile station device 200-k. For example, the channel estimation unit 205 of the mobile station device 200-1 calculates a channel estimation value Ĥ₁₁ of a channel between the mobile station device 200-1 and the base station device 100-1, a channel estimation value Ĥ₁₂ of a channel between the mobile station device 200-1 and the base station device 100-2, and a channel estimation value Ĥ₁₃ of a channel between the mobile station device 200-1 and the base station device 100-3. Note that the channel estimation value Ĥₖⱼ is a value represented as a complex amplitude gain, and is represented with an amplitude value and a phase value in this embodiment.

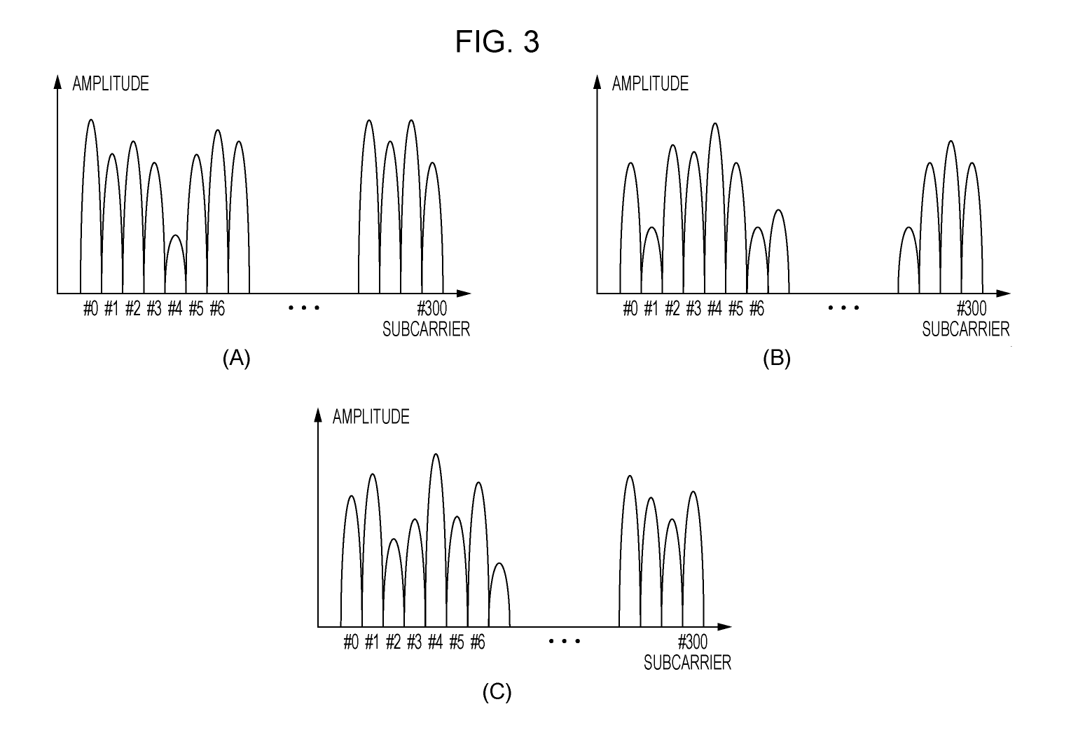

The amplitude values of the channel estimation value Ĥₖⱼ, estimated by the channel estimation unit 205 of the mobile station device 200-1 are as illustrated in FIG. 3. Note that FIG. 3(A) illustrates the amplitude values of Ĥ₁₁, FIG. 3(B) illustrates the amplitude values of Ĥ₁₂, and FIG. 3(C) illustrates the amplitude values of Ĥ₁₃. In a process below, channel state information is generated for an amplitude value. Channel state information can be generated also for a phase value in a similar manner.

The feedback information generation unit 207 generates channel state information that the mobile station device transmits to the base station device, by using the channel estimation value Ĥₖⱼ input from the channel estimation unit 205.

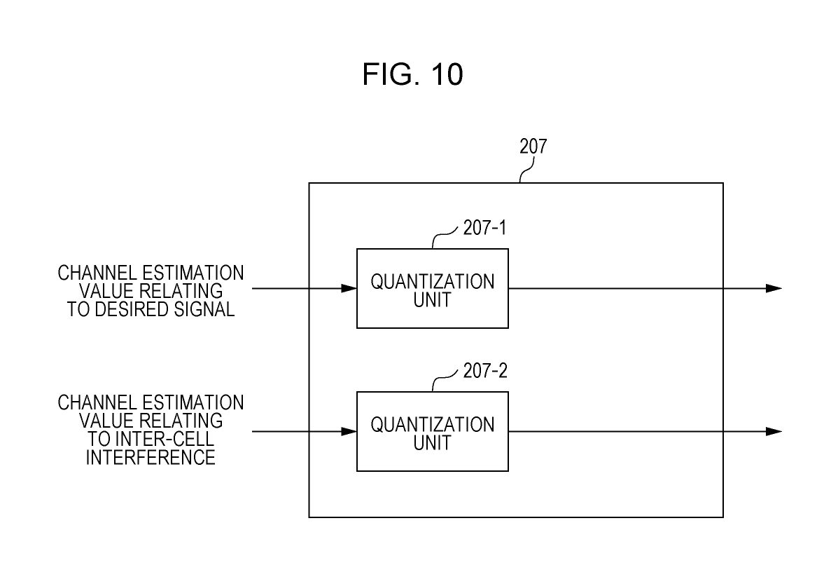

FIG. 10 is a schematic block diagram illustrating an example of a configuration of the feedback information generation unit 207 of the mobile station device 200-k in the communication system according to the first embodiment. As illustrated in FIG. 10, the feedback information generation unit 207 includes the quantization unit 207-1 and the quantization unit 207-2. The quantization unit 207-1 quantizes a channel estimation value relating to a desired signal, and the quantization unit 207-2 quantizes a channel estimation value relating to inter-cell interference. Specifically, the quantization unit 207-1 of the mobile station device 200-1 quantizes Ĥ₁₁, and the quantization unit 207-2 of the mobile station device 200-1 quantizes Ĥ₁₂ and Ĥ₁₃. In this case, the number of bits of channel state information for one channel estimation value Hₖⱼ is defined as the number of channel bits, and is assumed to be 3000 bits in this embodiment.

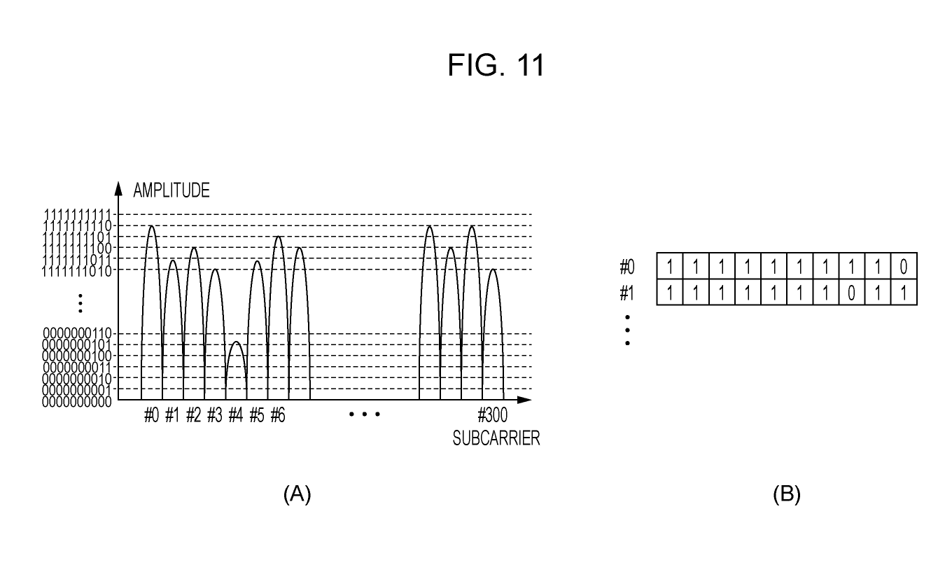

FIG. 11 includes diagrams illustrating an example of a process (quantization process) performed by the quantization unit 207-1 of the feedback information generation unit 207 of the mobile station device 200-k in the communication system according to the first embodiment. The quantization unit 207-1 performs quantization in order to represent a channel estimation value relating to a desired signal using the number of channel bits. The quantization unit 207-1 assumes that the number of quantization bits per subcarrier is 10 bits, which is obtained by dividing 3000 bits by 300 subcarriers, and quantizes each amplitude value using the number of quantization bits. FIG. 11 illustrates an example in which the amplitude values of Ĥ₁₁ (FIG. 3(A)) are each quantized into 10 bits, and each amplitude value is represented by a 10-bit value as illustrated in FIG. 11(A). FIG. 11(B) illustrates channel state information after quantization, and channel state information regarding a subcarrier #0 is represented by “1111111110”, and channel state information regarding a subcarrier #1 is represented by “1111111011”.

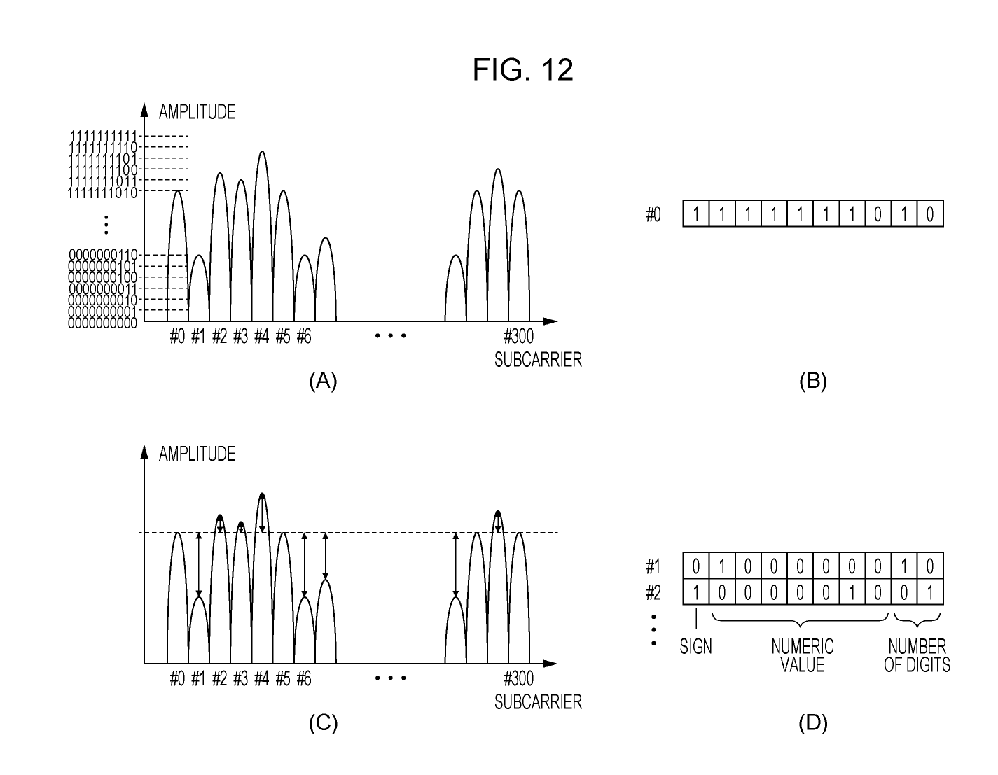

FIG. 12 includes diagrams illustrating an example of a process (quantization process) performed by the quantization unit 207-2 of the feedback information generation unit 207 of the mobile station device 200-k in the communication system according to the first embodiment. The quantization unit 207-2 quantizes a channel estimation value relating to inter-cell interference using the number of channel bits. In this case, the quantization unit 207-2 assumes the channel estimation value of the subcarrier of the first number to be a reference value, quantizes the reference value using the number of quantization bits per subcarrier (10 bits), and, for the channel estimation values of the other subcarriers, quantizes the difference from the reference value, which is the channel estimation value of the subcarrier of the first number, using the number of quantization bits. FIG. 12 illustrates an example in which the amplitude values of Ĥ₁₂ (FIG. 3(B)) are each quantized into 10 bits. A quantization process on the amplitude values of Ĥ₁₃ (FIG. 3(C)) is also performed similarly.

The quantization unit 207-2 quantizes the amplitude value of the subcarrier #0 (reference value) into 10 bits, and, for the other subcarriers, quantizes the amplitude difference from the reference value into 10 bits. Specifically, the quantization unit 207-2 quantizes the amplitude value of the subcarrier #0 into 10 bits (FIG. 12(A)), and obtains channel state information regarding the subcarrier #0 as illustrated in FIG. 12(B). Next, the quantization unit 207-2 calculates the amplitude difference from the reference value for the subcarrier #1 and the subsequent subcarriers, quantizes each amplitude difference into 10 bits (FIG. 12(C)), and obtains channel state information regarding each subcarrier as illustrated in FIG. 12(D). Note that the reference value may be obtained from a subcarrier of another number instead of the subcarrier #0. Here, it is assumed that the amplitude difference between the reference value and the amplitude value of the subcarrier #1 is −0.64, and the amplitude difference between the reference value and the amplitude value of the subcarrier #2 is +0.20.

FIG. 12(D) illustrates an example of bit assignment regarding the amplitude values. The first bit represents a positive or negative sign, the second to eighth bits represent a numeric value, and the ninth and tenth bits represent the number of digits, so that 10 bits are assigned to the amplitude value of each subcarrier. Specifically, in a case of the subcarrier #1, the amplitude value is −0.64=(−1)×64×(10⁻²). Therefore, the first bit is “0” because the amplitude value is negative, the second to eighth bits are “1000000”, which is obtained by converting 64 into binary, and the ninth and tenth bits are “10”, which is obtained by converting 2 into binary in order to represent the negative second power. Similarly, in a case of the subcarrier #2, the amplitude value is +0.20=(+1)×2×(10⁻¹), and therefore, the value is represented by “1000001001”. Note that the method for bit assignment is not limited to that illustrated in FIG. 11(D), and any method may be used as long as each amplitude difference can be represented using the number of quantization bits with as high an accuracy as possible. The bit assignment may be appropriately set on the basis of the relation between the value of an amplitude difference and the number of quantization bits.

The quantization unit 207-2 need not use the method as illustrated in FIG. 11(D), and may quantize the maximum value of the amplitude difference using the number of quantization bits (10 bits). This method is particularly effective in a case where a variation in the channel is small. A small amplitude difference can be represented using 10 bits, and therefore, highly accurate quantization is enabled compared with quantization performed by the quantization unit 207-1.

The quantization unit 207-2 may increase the number of quantization bits of the reference value. For example, the number of quantization bits of the reference value is set to 100 bits, and quantization is performed on the other subcarriers (subcarriers for each of which the amplitude difference is quantized) using the remaining number of bits (3000 bits−100 bits). As a result, the accuracy of quantization on a subcarrier that serves as a reference can be increased.

The quantization unit 207-2 may use a method for calculating an amplitude difference by using the difference from the amplitude value of the preceding subcarrier. For example, the amplitude difference from the amplitude value of the subcarrier #0 is calculated for the subcarrier #1, and the amplitude difference from the amplitude value of the subcarrier #1 is calculated for the subcarrier #2. This method is particularly effective in a case where a variation in the channel is small in the subcarrier direction.

Note that, in this embodiment, the number of quantization bits used and the quantization process performed in a case of generating channel state information may be determined in advance in the system, or may be determined by the base station device or the mobile station device. In a case where the base station device or the mobile station device transmits information about the number of quantization bits and the quantization process, the information may be contained in a control signal or the like and transmitted.

As described above, the quantization unit 207-1 quantizes each channel estimation value using the number of quantization bits. On the other hand, the quantization unit 207-2 quantizes the reference value using the number of quantization bits, and, for the other subcarriers, quantizes the difference from the reference value using the number of quantization bits. Accordingly, the quantization unit 207-2 represents only the amplitude difference from the reference value using the same number of quantization bits for subcarriers other than the subcarrier that serves as a reference, and therefore, a channel estimation value can be represented more precisely. As a result, particularly in a case where a variation in the channel in the subcarrier direction is small, the amount of information contained in channel state information relating to inter-cell interference, the channel state information being quantized by the quantization unit 207-2, is larger than the amount of information contained in channel state information relating to a desired signal, the channel state information being quantized by the quantization unit 207-1 (that is, more precise information is contained in the same number of bits), and therefore, the feedback accuracy regarding a channel relating to inter-cell interference can be increased. As described above, the feedback information generation unit 207 may be configured such that, in the quantization unit 207-2 (quantization on a channel relating to inter-cell interference), quantization is performed using a difference between the channel estimation values to thereby attain quantization with higher accuracy than in a case of the quantization unit 207-1 (quantization on a channel relating to inter-cell interference).

The feedback information generation unit 207 transmits the channel state information to the higher layer.

The control signal detection unit 211 detects a control signal contained in a signal output by the reception unit 202-e. The control signal detection unit 211 thereafter outputs reception weighting factor information contained in the control signal to the interference suppression unit 206.

The control signal detection unit 211 extracts various types of information contained in the control signal, such as resource block allocation information, MCS information, HARQ information, and TPC information. The control signal detection unit 211 thereafter detects information regarding information data addressed to the mobile station device 200-k (the allocation position of the information data addressed to the mobile station device 200-k, MCS applied to the information data, and the like) from the various types of information that have been extracted, and outputs the detected information to the demodulation unit 209 and the decoding unit 210.

The interference suppression unit 206 multiplies the frequency domain signal input from the FFT unit 204-e by the reception weighting factor Uₖ input from the control signal detection unit 211.

The channel compensation unit 208 calculates a weighting factor that corrects channel distortion caused by fading, on the basis of the channel estimation value input from the channel estimation unit 205, by using a method, such as ZF (Zero Forcing) equalization, MMSE (Minimum Mean Square Error) equalization, or the like. The channel compensation unit 208 multiplies a signal input from the interference suppression unit 206 by the weighting factor to thereby perform channel compensation.

The demodulation unit 209 performs a demodulation process on the signal after the channel compensation (data modulation symbol) input from the channel compensation unit 208. The demodulation process may be based on a hard decision (to calculate a coded bit sequence) or a soft decision (to calculate a coded bit LLR).

The decoding unit 210 performs an error correction decoding process on the coded bit sequence (or coded bit LLR) after the demodulation output by the demodulation unit 209, calculates the transmitted information data addressed to the mobile station device 200-k, and outputs the result to the higher layer 212. The method used in the error correction decoding process is a method corresponding to an error correction coding, such as turbo coding, convolutional coding, or the like, which has been performed by the base station device 100-j to which the mobile station device 200-k is connected. Any of the hard decision or the soft decision is applicable to the error correction decoding process.

In a case where the base station device 100-j transmits data modulation symbols that have been interleaved, the decoding unit 210 performs a deinterleaving process that corresponds to the interleaving performed on the coded bit sequence that has been input, before performing an error correction decoding process. The decoding unit 210 thereafter performs an error correction decoding process on the signal on which the deinterleaving process has been performed.

The higher layer 212 outputs channel state information to the control signal generation unit 221.

The control signal generation unit 221 generates control data that contains the channel state information generated by the feedback information generation unit 207. For example, in the communication system in FIG. 1, the control signal of the mobile station device 200-1 contains channel state information regarding the channels H₁₁, H₁₂, and H₁₃.

The control signal generation unit 221 generates control data that contains information regarding parameters of a downlink transmission signal (a CQI, an RI, other information relating to scheduling, and the like). The information regarding parameters of a downlink transmission signal is determined by the higher layer 212 on the basis of the channel estimation value calculated by the channel estimation unit 205.

The control signal generation unit 221 performs an error correction coding and modulation mapping on the control data to thereby generate a control signal. Signals including the control signal output by the control signal generation unit 221 are up-converted by the transmission unit 222 into signals of a frequency band in which downlink transmission is possible, and are transmitted to the base station device 100-j to which the mobile station device 200-k is connected, via the transmission antenna unit 223.

Note that information regarding the quantization process used in the feedback information generation unit 207 may be transmitted from the mobile station device to the base station device, or may be determined in advance in the communication system.

[Overall Operations in Communication System]

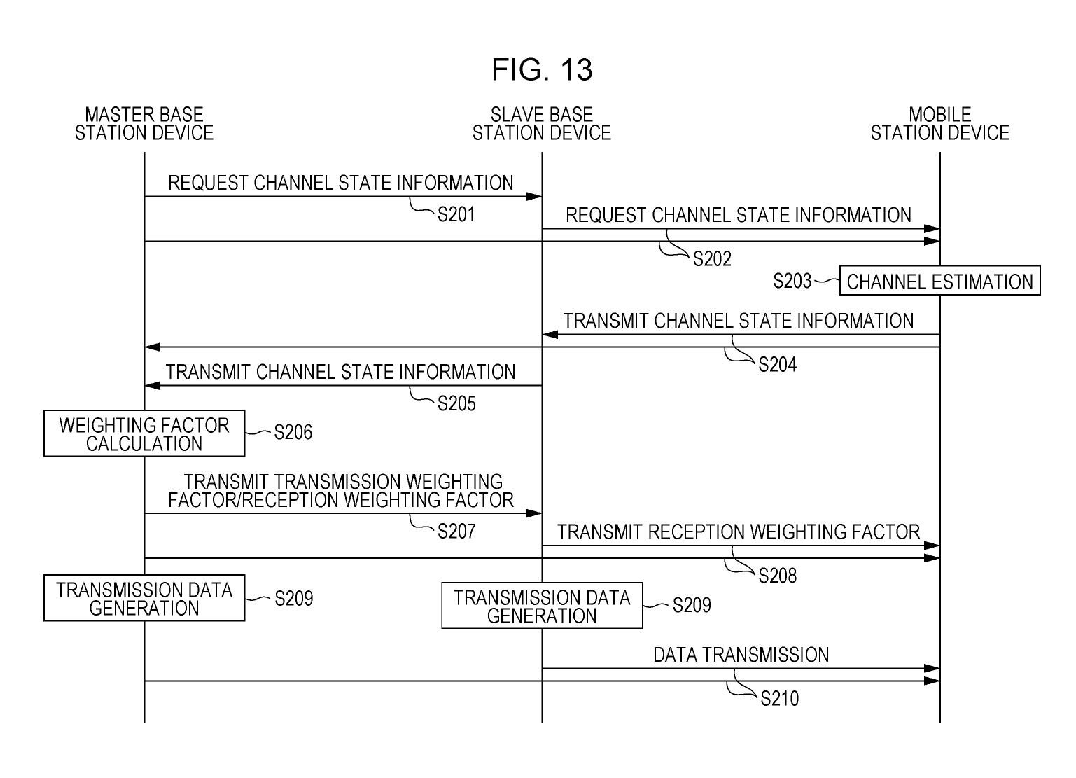

FIG. 13 is a sequence chart illustrating an example of operations among the base station devices and the mobile station device in the communication system according to this embodiment.

In step S201, the master base station device makes a request for channel state information to the slave base station device using the backhaul line.

In step S202, each base station device makes a request for channel state information to a mobile station device that is connected to the base station device. Specifically, the master base station device (base station device 100-1) makes a request for channel state information to the mobile station device 200-1, the base station device 100-2 (slave base station device) makes a request for channel state information to the mobile station device 200-2, and the base station device 100-3 (slave base station device) makes a request for channel state information to the mobile station device 200-3.

In step S203, the mobile station device that has received the request for channel state information performs channel estimation, and generates channel state information. Specifically, the channel estimation unit 205 performs channel estimation, and the feedback information generation unit 207 generates channel state information from the channel estimation value.

In step S204, each mobile station device transmits the channel state information to the slave base station device to which the mobile station device is connected.

In step S205, the slave base station device transmits the channel state information to the master base station device using the backhaul line.

In step S206, the master base station device calculates the transmission weighting factor Vⱼ or/and the reception weighting factor Uₖ on the basis of the channel state information that has been transmitted. This process is performed by the weighting factor calculation unit 105.

In step S207, the master base station device transmits the transmission weighting factor Vⱼ or/and the reception weighting factor Uₖ to the salve base station device using the backhaul line. For example, the base station device 100-2 receives the transmission weighting factor V₂ that is used by the base station device 100-2 and the reception weighting factor U₂ that is used by the mobile station device 200-2.

In step S208, each base station device transmits the reception weighting factor Uₖ to the mobile station device that is connected to the base station device. For example, the mobile station device 200-2 that is connected to the slave base station device 100-2 obtains the reception weighting factor U₂ from the master base station device 100-1 via the slave base station device 100-2. Note that, while a coordinated control method using a transmission weighting factor and a reception weighting factor is employed in this embodiment, in a case of employing a coordinated control method that only uses a transmission weighting factor, the process in step S208 is not necessary.

In step S209, each base station device multiplies information data to be transmitted to the mobile station device that is connected to the base station device by the transmission weighting factor Vⱼ, adds a control signal or the like to the information data to thereby generate transmission data.

In step S210, each base station device transmits the transmission data to the mobile station device that is connected to the base station device.

As described above, in this embodiment, in a case of calculating channel state information, channel state information relating to a desired signal is quantized using an amplitude value, and channel state information relating to inter-cell interference is quantized using an amplitude difference. Accordingly, the amount of information contained in the channel state information relating to inter-cell interference can be made larger than the amount of information contained in the channel state information relating to a desired signal. As a result, in a case of a coordinated control method that only uses a transmission weighting factor, it is possible to calculate, with high accuracy, a transmission weight used by each base station device to perform coordinated control, and a high degree of interference suppression effect can be attained. In a case of a coordinated control method that uses a transmission weighting factor and a reception weighting factor, it is possible to calculate, with high accuracy, a transmission weight used by each base station device to perform coordinated control and reception weights used by respective mobile station devices, as weighting factors for suppressing inter-cell interference, and a high degree of interference suppression effect can be attained.

### Second Embodiment

In the first embodiment, a channel estimation value is quantized for each subcarrier, and channel state information is generated without changing the number of channel bits (which is the number of bits necessary for quantizing a channel estimation value per channel, and is 3000 bits in the first embodiment). In the second embodiment, a channel estimation value for each subcarrier is converted into time-base information, and channel state information is generated without changing the number of channel bits (which is assumed to be 3000 bits in the second embodiment as in the first embodiment). Note that the system configuration and the block configurations of the base station device and the mobile station device are similar to those of the first embodiment, and therefore, only description of differences from the first embodiment will be given below.

[Mobile Station Device]

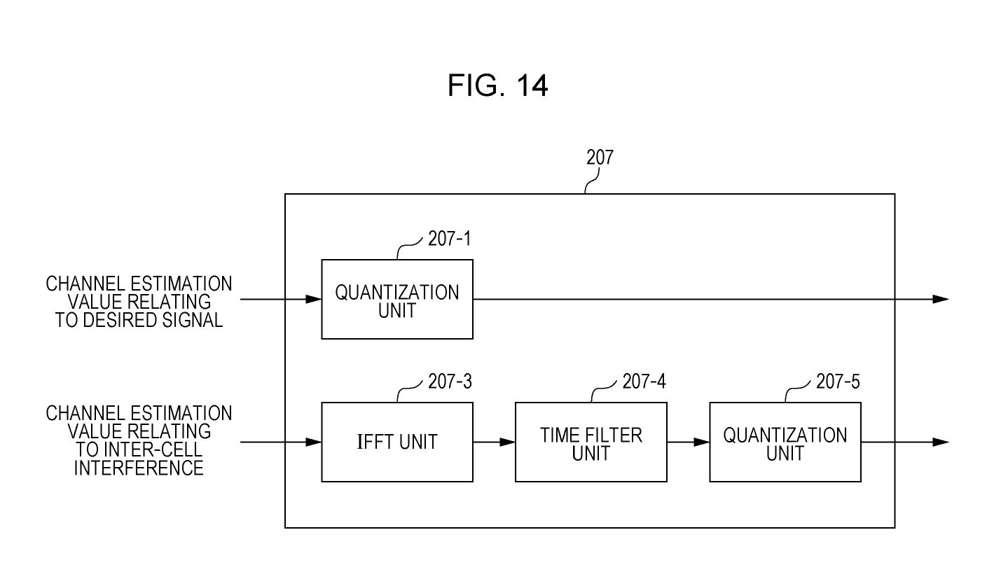

FIG. 14 is a schematic block diagram illustrating an example of a configuration of the feedback information generation unit 207 of the mobile station device 200-k in a communication system according to the second embodiment. As illustrated in FIG. 14, the feedback information generation unit 207 includes the quantization unit 207-1, an IFFT unit 207-3, a time filter unit 207-4, and a quantization unit 207-5. That is, in the second embodiment, the quantization unit 207-2 in the first embodiment is replaced by the IFFT unit 207-3, the time filter unit 207-4, and the quantization unit 207-5. The quantization unit 207-1 quantizes a channel estimation value relating to a desired signal, and the IFFT unit 207-3, the time filter unit 207-4, and the quantization unit 207-5 quantize a channel estimation value relating to inter-cell interference.

The quantization unit 207-1 performs the same process as the quantization unit 207-1 in the first embodiment, and the amplitude values of the channel estimation value Ĥ₁₁ are each quantized into 10 bits for each subcarrier, as illustrated in FIG. 12(B). As a result, the number of channel bits relating to the amplitude values of the channel estimation value Ĥ₁₁ becomes 3000 bits (10 bits×300 subcarriers).

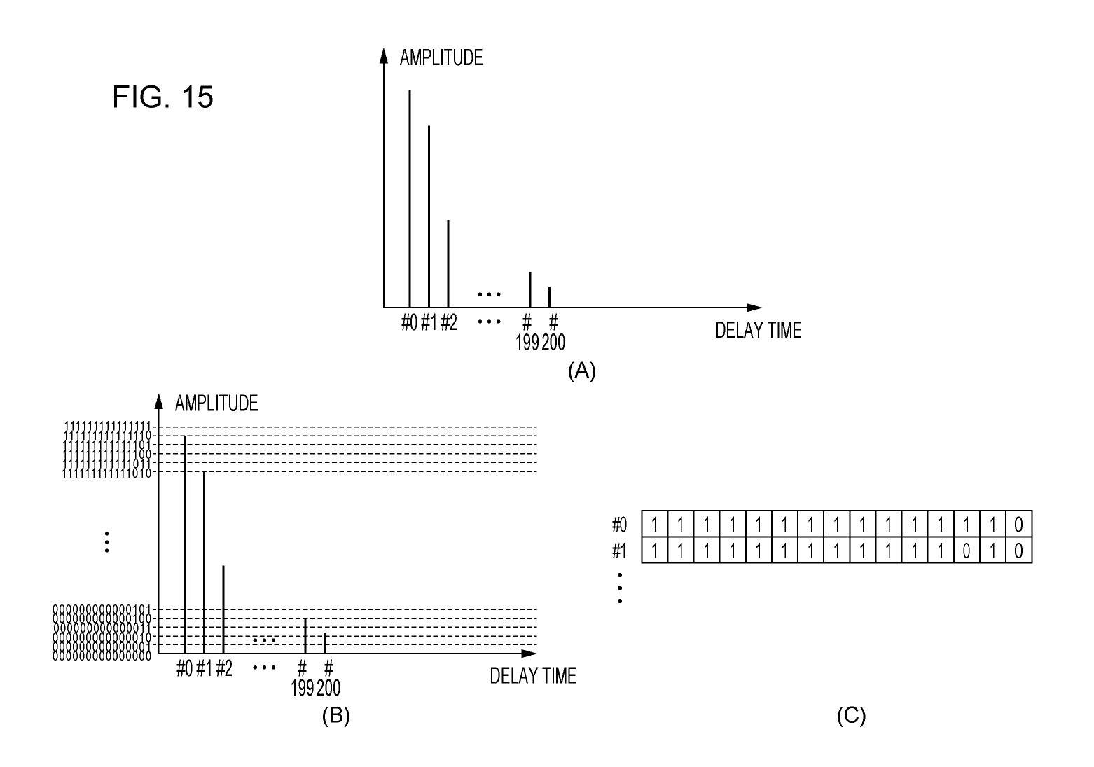

FIG. 15 includes diagrams illustrating an example of a quantization process for quantizing channel estimation values relating to inter-cell interference according to the second embodiment. The IFFT unit 207-3 performs inverse fast Fourier transform (IFFT) on channel estimation values that have been input, generates impulse responses, and outputs the impulse responses to the time filter unit 207-4. The time filter unit 207-4 applies a time window in a predetermined range on the impulse responses that have been input, extracts paths included in the time window, and outputs the paths to the quantization unit 207-5. In this embodiment, it is assumed that the maximum delay time of the impulse response is 200 samples, and the time window has a range of 200 samples starting from the first sample, for example. FIG. 15(A) illustrates impulse responses in a case where inverse fast Fourier transform is performed on the amplitude values of the channel estimation value Ĥ₁₂ (FIG. 3(B)) and paths included in the time window are extracted. In this embodiment, an example is given in which impulse responses are entirely included in the range of the time window; however, it is difficult for the mobile station device to accurately grasp the maximum delay time. Therefore, the GI length designed for the system may be used as an index for setting the range of the time window, or the maximum delay time of a path that has a path energy higher than a certain threshold may be used. Any range of the time window is covered by the present invention.

The time filter unit 207-4 may select and extract any path from among paths included in the time window, as well as extracting all paths included in the time window. For example, a method of extracting a path having a path energy higher than a certain threshold is conceivable.

Next, the quantization unit 207-5 quantizes the impulse responses input from the time filter unit 207-4. In this case, the number of channel bits is made equal to the number of bits used in the quantization unit 207-1. Specifically, the quantization unit 207-5 performs quantization such that the number of bits per path (tap) is 15 bits (3000 bits/200 paths), so that the number of channel bits of the estimation value Ĥ₁₂ is 3000. In this case, a path #0 and a path #1 are quantized as illustrated in FIG. 15(C), for example.

As described above, the feedback information generation unit in this embodiment converts a channel estimation value for each subcarrier into an impulse response, and generates channel state information without changing the number of channel bits after quantization on one channel estimation value. Accordingly, while a channel estimation value relating to a desired signal is represented using 10 bits, a channel estimation value relating to inter-cell interference can be represented using 15 bits, thereby attaining increase in the feedback accuracy regarding a channel estimation value relating to inter-cell interference. Consequently, it is sufficient that the feedback information generation unit 207 in this embodiment is configured such that, in the IFFT unit 207-3, the time filter unit 207-4, and the quantization unit 207-5 (quantization on a channel relating to inter-cell interference), a channel estimation value is converted into an impulse response and a quantization process is performed on the impulse response to thereby implement quantization with higher accuracy than in the quantization unit 207-1 (quantization on a channel relating to inter-cell interference).

[Base Station Devices (Master Base Station Device and Slave Base Station Device)]

The channel state information detection unit 124 of the master base station device (FIG. 6) and the channel state information detection unit 124 of the slave base station device (FIG. 8) perform fast Fourier transform (FFT) on channel state information relating to inter-cell interference, and converts the channel state information that has been transmitted into channel state information for each subcarrier. Specifically, the channel state information detection unit 124 of the master base station device and the channel state information detection unit 124 of the slave base station device each generate impulse responses (FIG. 15(B)) from the channel state information that has been transmitted (FIG. 15(C)), and convert the impulse responses into the amplitude values of respective subcarriers (FIG. 3(B)).

As described above, in this embodiment, in a case of calculating channel state information, channel state information relating to a desired signal is quantized for each subcarrier, and channel state information relating to inter-cell interference is quantized after a process of conversion into impulse responses has been performed. Accordingly, the amount of information contained in channel state information relating to inter-cell interference can be made larger than the amount of information contained in channel state information relating to a desired signal. As a result, it is possible to calculate a weighting factor for suppressing inter-cell interference, and a high degree of interference suppression effect can be attained.

In the above-described embodiments, the configurations and the like are not limited to those illustrated in the attached drawings, and may be modified as appropriate as long as the advantages of the present invention are attained. In addition, the configurations and the like may be modified as appropriate and implemented without departing from the scope of the object of the present invention.

A program for implementing the functions described in the embodiments may be recorded in a computer readable recording medium, and the program recorded in the recording medium may be loaded to a computer system and executed to thereby perform the processes in the units. Note that the “computer system” mentioned here includes an OS and hardware, such as a peripheral device.

Moreover, the “computer system” includes a Web page providing environment (or a Web page display environment) if a WWW system is used.

The “computer readable recording medium” is a portable medium, such as a flexible disk, a magneto-optical disk, a ROM, or a CD-ROM, or a storage device integrated into the computer system, such as a hard disk. Moreover, examples of the “computer readable recording medium” include a medium that dynamically retains the program for a short period of time, such as a communication line used in a case where the program is transmitted via a network, such as the Internet, or a communication circuit, such as a telephone circuit, and a medium that retains the program for a certain period of time, such as a volatile memory, provided inside a computer system that serves as a server or a client used in the above case. The program may be a program for implementing some of the above-described functions, or the program may be combined with a program that has already been recorded in the computer system to thereby implement the above-described functions.

### REFERENCE SIGNS LIST

10 backhaul line
10-1, 10-2, 10-3 (10a-1, 10a-2, 10a-3) cell
100-1, 100-2, 100-3 (100a-1, 100a-2, 100a-3) base station device
101 higher layer
102 encoding unit
103 modulation unit
104 precoding unit
105 weighting factor calculation unit
106 reference signal generation unit
107 control signal generation unit
108 resource mapping unit
109 IFFT unit
110 GI insertion unit
111 transmission unit
112 transmission antenna unit
121 reception antenna unit
122 reception unit
123 control signal detection unit
124 channel state information detection unit
151 higher layer
157 control signal generation unit
200-1, 200-2, 200-3 (200a-1, 200a-2, 200a-3) mobile station device
201-1, 201-2 reception antenna unit
202-1, 202-2 reception unit
203-1, 203-2 GI removal unit
204-1, 204-2 FFT unit
205 channel estimation unit
206 interference suppression unit
207 feedback information generation unit
207-1, 207-2, 207-5 quantization unit
207-3 IFFT unit
207-4 time filter unit
208 channel compensation unit
209 demodulation unit
210 decoding unit
211 control signal detection unit
212 higher layer
221 control signal generation unit
222 transmission unit
223 transmission antenna unit

1. A mobile station device comprising:
a channel estimation unit that generates a first channel estimation value of a channel between the mobile station device and a base station device to which the mobile station device is connected, and a second channel estimation value of a channel between the mobile station device and a base station device other than the base station device to which the mobile station device is connected;
a feedback information generation unit that generates first channel state information and second channel state information using an identical number of channel bits while making an amount of information contained in the second channel state information larger than an amount of information contained in the first channel state information, the first channel state information being used to transmit the first channel estimation value to a base station device, the second channel state information being used to transmit the second channel estimation value to a base station device; and
a transmission unit that transmits the first channel state information and the second channel state information to the base station device to which the mobile station device is connected.

2. The mobile station device according to claim 1, wherein
the feedback information generation unit includes a first quantization unit configured to generate the first channel state information, and a second quantization unit configured to generate the second channel state information,
the first quantization unit is configured to perform a quantization process of calculating a first number of quantization bits so as to make a product of the first number of quantization bits and a number of subcarriers equal to or less than the number of channel bits, and quantizing first channel estimation values for respective subcarriers by using the first number of quantization bits, and
the second quantization unit is configured to perform a quantization process of assuming a second channel estimation value relating to a subcarrier as a reference value, quantizing the reference value by using the first number of quantization bits, calculating differences between the reference value and second channel estimation values other than the reference value for the respective subcarriers, and quantizing the differences for the respective subcarriers by using the first number of quantization bits.

3. The mobile station device according to claim 2, wherein
the second quantization unit is configured to make a third number of quantization bits used in quantizing a value other than the reference value less than a second number of quantization bits used in quantizing the reference value.

4. The mobile station device according to claim 2, wherein
the second quantization unit is configured to quantize a difference between a second channel estimation value relating to a subcarrier and a second channel estimation value relating to a contiguous subcarrier by using the first number of quantization bits.

5. The mobile station device according to claim 2, wherein
the second quantization unit includes
an IFFT unit configured to convert the second channel estimation values for the respective subcarriers into impulse responses for respective paths,
a time filter unit configured to extract paths within a predetermined range from the impulse responses, and
a third quantization unit configured to calculate a fourth number of quantization bits so as to make a product of a number of paths that have been extracted and the fourth number of quantization bits equal to or less than the number of channel bits, and quantize the impulse responses by using the fourth number of quantization bits.

6. A communication method used in a mobile station device that communicates with a base station device, the method comprising:
generating a first channel estimation value of a channel between the mobile station device and a base station device to which the mobile station device is connected, and a second channel estimation value of a channel between the mobile station device and a base station device other than the base station device to which the mobile station device is connected;
generating first channel state information and second channel state information using an identical number of channel bits while making an amount of information contained in the second channel state information larger than an amount of information contained in the first channel state information, the first channel state information being used to transmit the first channel estimation value to a base station device, the second channel state information being used to transmit the second channel estimation value to a base station device; and
transmitting the first channel state information and the second channel state information to the base station device to which the mobile station device is connected.

7. A communication system comprising:
a mobile station device including
a channel estimation unit that generates a first channel estimation value of a channel between the mobile station device and a base station device to which the mobile station device is connected, and a second channel estimation value of a channel between the mobile station device and a base station device other than the base station device to which the mobile station device is connected,
a feedback information generation unit that generates first channel state information and second channel state information using an identical number of channel bits while making an amount of information contained in the second channel state information larger than an amount of information contained in the first channel state information, the first channel state information being used to transmit the first channel estimation value to a base station device, the second channel state information being used to transmit the second channel estimation value to a base station device, and
a transmission unit that transmits the first channel state information and the second channel state information to the base station device to which the mobile station device is connected; and
base station devices including
a reception unit that receives the first channel state information and the second channel state information transmitted by the mobile station device.

8. The communication system according to claim 7, wherein
the base station devices include
a higher layer that transmits the first channel state information and the second channel state information to a main base station device in a case of receiving the first channel state information and the second channel state information, and
the base station devices include
a weighting factor calculation unit that calculates a transmission weight used in coordinated control, by using the first channel state information and the second channel state information.

9. The communication system according to claim 8, wherein
the weighting factor calculation unit further calculates a reception weight used by each mobile station device, and the mobile station device includes a demodulation unit that performs demodulation using the reception weight.
